(19) United States
(12) Patent Application Publication
(10) Pub. No.: US 2009/0160220 A1
(43) Pub. Date: Jun. 25, 2009

(54) MOTOR VEHICLE WINDOW ASSEMBLY

(75) Inventor: William Glen Elijah, GOSHEN, IL (US)

Correspondence Address: BANNER & WITCOFF, LTD., 28 STATE STREET, 28th FLOOR, BOSTON, MA, 02109-9601, US

(73) Assignee: ATWOOD MOBILE PRODUCTS, LLC, Elkhart, IN (US)

(21) Appl. No.: 11/959,887

(22) Filed: Dec. 19, 2007

(51) Int. Cl. E06B 1/04; B60J 1/08; F16J 15/00

(52) U.S. Cl. 296/201; 52/213; 277/650

(57) ABSTRACT

A motor vehicle window assembly includes a first window frame member and a stationary pane received by the first window frame member. A window frame retainer member is secured at a first end thereof to the first window frame member. A second end of the window frame retainer member is secured to a second window frame member. A movable pane is movable along the second window frame member. The first and second window frame members are proximate one another and free of any structural members therebetween.

### FIELD OF THE INVENTION

This invention relates generally to a motor vehicle window assembly, and, in particular, to a motor vehicle window assembly with improved support and visibility.

### BACKGROUND OF THE INVENTION

Motor vehicles, for example, recreational vehicles, may have a stationary window pane within which a movable window pane is positioned. The stationary and movable panes are typically attached to one another with a structural member positioned therebetween, which can hamper visibility. The movable window pane is typically manually operated, but may be power operated as well.

A prior art motor vehicle window assembly 10 having a frame 12 is seen in FIGS. 1-2. Frame 12 receives a stationary pane 14 and a movable pane 16 positioned within stationary pane 14 and which may be raised and lowered as desired to provide ventilation to the interior of the vehicle (not shown). As seen in FIG. 2, frame 12 includes a first stationary window frame member 18 supporting stationary pane 14. A second movable window frame member 20 supports movable pane 16. A structural support member 22, such as a wall support or pillar, is positioned between stationary window frame member 18 and movable window frame member 20. The term structural support member as used herein refers to a member that primarily serves to provide structural support for the window assembly or the motor vehicle within which the window assembly is installed, or both. Exemplary structural members include pillars and wall members. Structural support member 22 is typically formed of metal, such as steel, for example.

A first frame retainer member 24 is secured at a first end thereof to stationary window frame member 18 with a fastener 26. A second end of first frame retainer member 24 engages an interior surface of support member 22. Similarly, a second frame retainer member 28 is secured at a first end thereof to movable window frame member 20 with a fastener 26. Fasteners 26 may be screws, bolts, or any other suitable fastener. A second end of second frame retainer member 28 engages an exterior surface of support member 22. First and second frame retainer members 24, 28 serve to secure stationary pane 14 and movable pane 16 together as well as capture support member 22 therebetween.

Stationary window frame member 18, movable window frame member 20, first and second frame retainer members 24, 28, and support member 22 define a light obscuring portion of window assembly 10 having a width P, as seen in FIG. 2, which is approximately 3¼ inches (82.6 mm).

It would be desirable to provide a motor vehicle window assembly that reduces or overcomes some or all of the difficulties inherent in prior known devices. Particular objects and advantages will be apparent to those skilled in the art, that is, those who are knowledgeable or experienced in this field of technology, in view of the following disclosure of the invention and detailed description of certain embodiments.

### SUMMARY

The principles of the invention may be used to advantage to provide a motor vehicle window assembly. In accordance with a first aspect, a motor vehicle window assembly includes a first window frame member and a stationary pane received by the first window frame member. A window frame retainer member is secured at a first end thereof to the first window frame member. A second end of the window frame retainer member is secured to a second window frame member. A movable pane is movable along the second window frame member. The first and second window frame members are proximate one another and free of any structural members therebetween.

In accordance with another aspect, a motor vehicle window assembly includes a first window frame member. A stationary pane is received by the first window frame member and defines a first plane. A window frame retainer member is secured at a first end thereof to the first window frame member. A second end of the window frame retainer member is secured to a second window frame member. A movable pane is movable along the second window frame member and defines a second plane. The first and second planes are substantially parallel to one another. A portion of the first window frame member and a portion of the second window frame member overlap one another along a third plane extending substantially parallel to the first and second planes.

In accordance with a further aspect, a motor vehicle window assembly includes a first window frame member. A stationary pane is received by the first window frame member and defines a first plane. A window frame retainer member is secured at a first end thereof to the first window frame member by a first plurality of fasteners. A second end of the window frame retainer member is secured to a second window frame member by a second plurality of fasteners. A movable pane is movable along the second window frame member and defines a second plane. The first and second planes are substantially parallel to one another. A first seal is positioned between a portion of the first window frame member and the second window frame member. A second seal is positioned between the first window frame member and the second window frame member. A portion of the first window frame member and a portion of the second window frame member overlap one another along a third plane extending substantially parallel to the first and second planes.

In accordance with yet another aspect, a motor vehicle window assembly for a motor vehicle includes a first modular portion having a first frame member and a first light admitting pane supported by the first frame member. The first light admitting pane has an elongated horizontal portion and an elongated vertical portion. A second modular portion includes a second frame member and a movable light admitting pane supported by the second frame member. A regulator is supported by the second modular portion and is connected to the movable light pane. The second modular portion is at least partially surrounded by the elongated horizontal portion and the elongated vertical portion of the first light admitting pane on at least two sides. At least a portion of the first and the second frame members are coupled to one another to be self supporting, the combined first and second frame members defining a light obscuring portion between the elongated vertical portion and the second light admitting pane having a width that is less than about 2 inches.

Substantial advantage is achieved by providing such a motor vehicle window assembly. In particular, certain embodiments of a motor vehicle window assembly provide increased visibility and enhanced aesthetic appeal.

These and additional features and advantages disclosed here will be further understood from the following detailed disclosure of certain embodiments.

### BRIEF DESCRIPTION OF THE DRAWINGS

FIG. 1 is an elevation view of a prior art motor vehicle window assembly.

FIG. 2 is a section view of a portion of the frame of the motor vehicle window assembly of FIG. 1, taken along line 2-2.

FIG. 3 is an elevation view of a motor vehicle window assembly.

FIG. 4 is a section view of a portion of the frame of the motor vehicle window assembly of FIG. 3, taken along line 4-4.

The figures referred to above are not drawn necessarily to scale, should be understood to provide a representation of particular embodiments of the invention, and are merely conceptual in nature and illustrative of the principles involved. Some features of the motor vehicle window assembly depicted in the drawings have been enlarged or distorted relative to others to facilitate explanation and understanding. The same reference numbers are used in the drawings for similar or identical components and features shown in various alternative embodiments. Motor vehicle window assemblies as disclosed herein would have configurations and components determined, in part, by the intended application and environment in which they are used.

### DETAILED DESCRIPTION OF CERTAIN PREFERRED EMBODIMENTS

It will be apparent to those skilled in the art, that is, to those who have knowledge or experience in this area of technology, that many uses and design variations are possible for the motor vehicle window assembly disclosed here. The following detailed discussion of various alternative and preferred features and embodiments will illustrate the general principles of the invention with reference to a sliding window positioned within a motor vehicle, such as a recreational vehicle (RV). Other embodiments suitable for other applications will be apparent to those skilled in the art given the benefit of this disclosure.

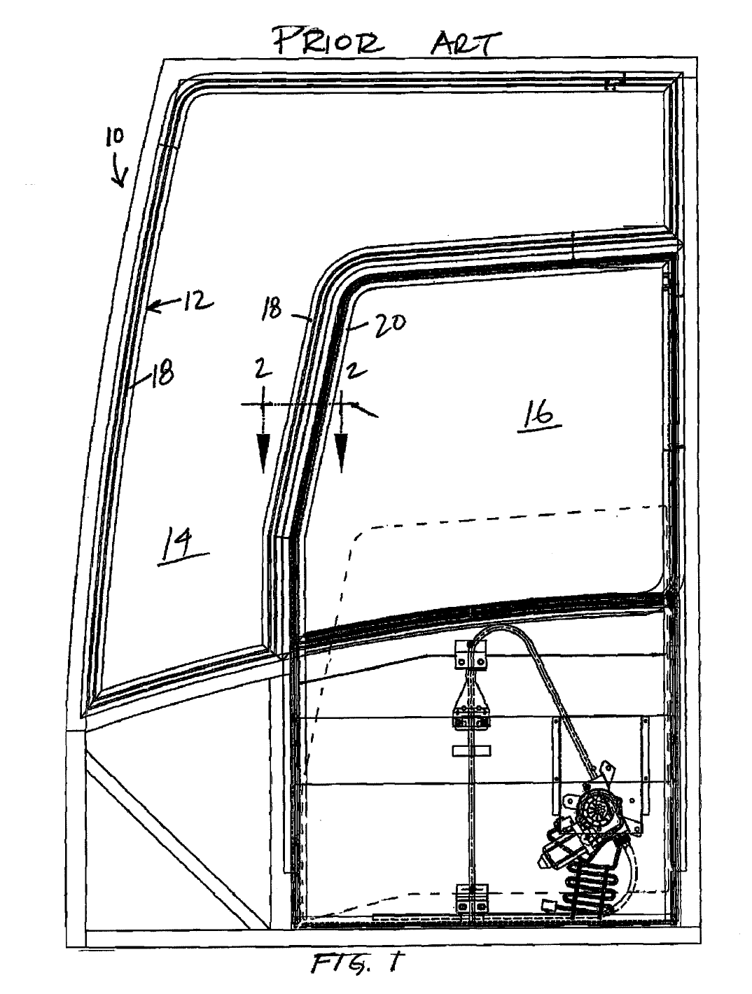

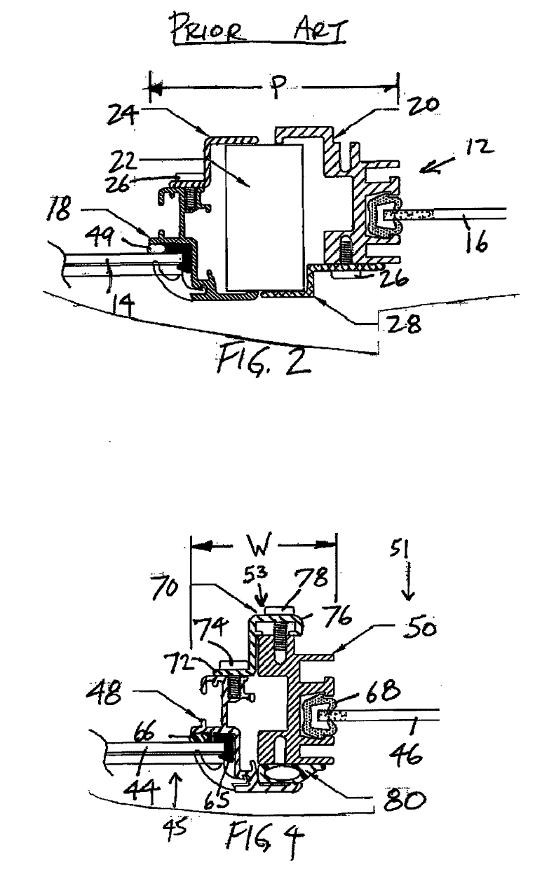

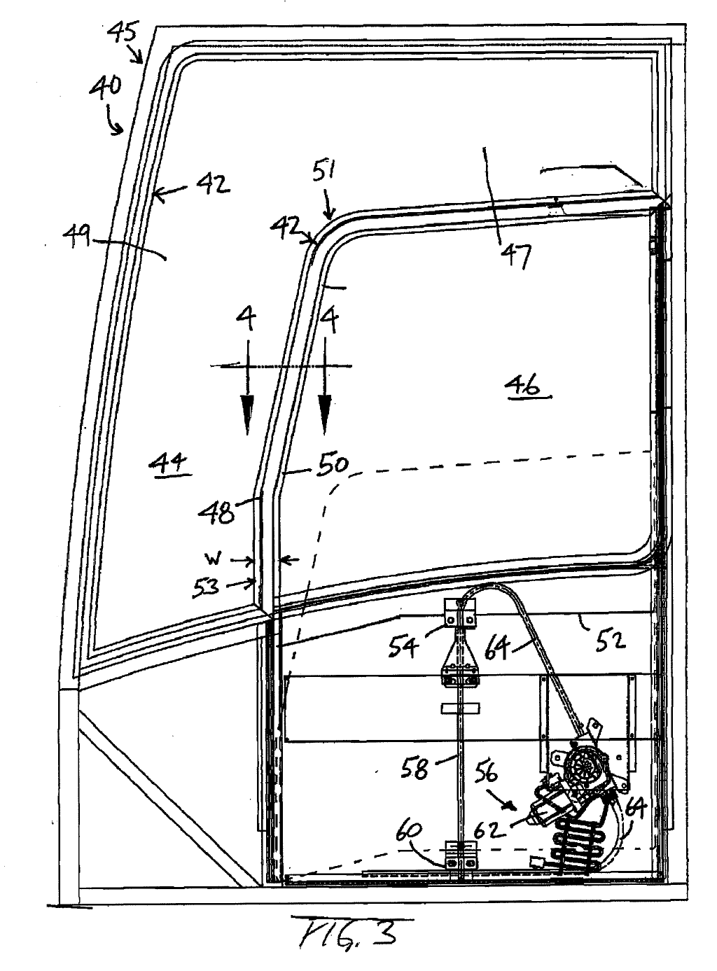

The terms interior and exterior or inside and outside are used here to refer generally to the front and back of a motor vehicle window assembly. Thus, the exterior side or surface of the motor vehicle window assembly embodiment shown in FIGS. 1 and 3 is the side viewed in the drawing and the interior side or surface is the opposite side, i.e., the side facing away from the viewer. In automotive applications, for example, the interior or inside of the motor vehicle window assembly is the side facing into the passenger compartment (or designed, when installed, to face into the passenger compartment). Correspondingly, the exterior faces outwardly, e.g., to the weather.

An embodiment of a motor vehicle window assembly 40 is shown in FIG. 3. Window assembly 40 includes a frame 42, which may be formed of extruded metal, such as aluminum, and which is secured in a conventional manner to a vehicle frame. Window assembly 40 is generally adapted for use in an RV, but will no doubt find usefulness in a wide variety of other vehicles and trucks. Frame 42 as shown accommodates a first light admitting pane, or stationary pane 44 defining a first plane and supported by a first stationary window frame member 48, with stationary pane 44 and stationary window frame member forming a first modular portion 45 of window assembly 40. Stationary pane 44 includes an elongated horizontal portion 47 and an elongated vertical portion 49.

A second movable light admitting pane such as a movable pane 46 defines a second plane, is positioned within stationary pane 44, that is, movable pane 46 is at least partially surrounded by elongated horizontal portion 47 and elongated vertical portion 49 of stationary pane 44. Thus, movable pane 46 is enclosed on at least two sides by stationary pane 44. Movable pane 46 is supported by and moves along a second movable window frame member 50, with movable pane 46 and movable window frame member 50 forming a second modular portion 51 of window assembly 40. Movable pane 46 may be advantageously raised and lowered as desired to provide ventilation to the interior of the vehicle (not shown).

In certain embodiments, each of stationary window frame member 48 and movable window frame member 50 of frame 42 include at least one bend, which serves to reinforce frame 42 against lateral loading. In the illustrated embodiments, at least one corner of each of stationary window frame member 48 and movable window frame member 50 include a bend.

It should be understood that reference here to a plane, e.g., the plane of stationary pane 44 and that of movable pane 46, is intended to broadly cover true planes, i.e., simple flat surfaces or imaginary spaces, as well as curvo-planar surfaces and shapes (e.g., similar to the surface of a typical motor vehicle's roof or fender) and multi-planar surfaces and shapes where the multiple planes are fairly viewed as all being parts of a larger, generally planar or curvo-planar surface or shape. In certain exemplary embodiments, for example, each of stationary pane 44 and movable pane 46 may be curved, perhaps having a surface which is a complex curve, but which nevertheless is fairly seen to be generally planar (in this instance generally curvo-planar).

Movable pane 46 is connected at its bottom edge 52 to a support bracket 54. Movable pane 46 slides between its up position and the full down position (shown in dotted lines in FIG. 3) within movable window frame member 50. Support bracket 54 is slidably connected to a regulator assembly 56, which is shown as a power actuated assembly in the drawings. It is to be appreciated that a manual regulator could be used to operate movable pane 46 in certain embodiments.

Regulator assembly 56 is common in the industry and includes a slide rod 58, which accommodates support bracket 54 and is attached to a bottom of frame 12 through a bracket assembly 60. Regulator assembly 56 also includes a motor 62 and cables 64, which are arranged in a manner common to the automotive power window industry and will not be described in detail.

As seen in FIG. 4, stationary pane 44 is bonded about its peripheral edge to stationary window frame member 48, by a bead 65 formed of urethane, for example. A resilient first seal 66 may be positioned between stationary window frame member 48 and stationary pane 44. Movable window frame member 50 includes a run channel 68 that receives a peripheral edge of movable pane 46. In certain embodiments, it is to be appreciated that stationary pane 44 may be seated in a run channel within stationary frame member 48 without being bonded thereto.

A window frame retainer member 70 is secured at a first end 72 thereof to an interior surface of stationary window frame member 48 with a first plurality of fasteners 74 (only one visible here). A second end 76 of window frame retainer member 70 is secured to an interior surface of movable window frame member 50 with a second plurality of fasteners 78 (only one visible here). First and second fasteners 74, 78 may be screws or bolts, for example, or any other suitable fastener. It is to be appreciated that, in certain embodiments, window frame retainer member 70 may be directly secured to stationary window frame member 48 and movable window frame member 50 without separate fastening elements, such as by a friction-fit engagement, a snap-fit engagement, or any other suitable mechanical interconnection means.

In certain embodiments, window frame retainer member 70 is in direct contact with stationary window frame member 48 and movable window frame member 50. Stationary window frame member 48 and movable window frame member 50 are proximate one another and free of any structural members therebetween. That is, at least a portion of stationary window frame member 48 and movable window frame member 50 are coupled to one another so as to be self-supporting. In other words, there is no structural support member, pillar or any other support providing member positioned between stationary window frame member 48 and movable window frame member 50. This advantageously reduces the size of the frame components between stationary pane 44 and movable pane 46, thereby improving visibility through window assembly 40, as well as enhancing its aesthetic appeal and providing serviceability for each pane independently of the other.

The portions of stationary window frame member 48 and movable window frame member 50 that are positioned between elongated vertical portion 49 of stationary pane 44 and movable pane 46 define a light obscuring portion 53 having a width W, as seen in FIG. 4. In certain embodiments, width W is less than approximately 2 inches (51 mm). In certain embodiments, width W is less than approximately 1¾ inches (44.5 mm).

A portion of stationary window frame member 48 overlaps a portion of movable window frame member 50 along a plane extending substantially parallel to the first and second planes defined by stationary pane 44 and movable pane 46, respectively. In certain embodiments a second resilient seal 80 is positioned between stationary window frame member 48 and movable window frame member 50 in the area in which they overlap. First seal 66 and second seal 80 may be formed of an elastomeric material such as ethylene propylene diene monomer (EPDM), for example.

Thus, while there have been shown, described, and pointed out fundamental novel features of various embodiments, it will be understood that various omissions, substitutions, and changes in the form and details of the devices illustrated, and in their operation, may be made by those skilled in the art without departing from the spirit and scope of the invention. For example, it is expressly intended that all combinations of those elements and/or steps which perform substantially the same function, in substantially the same way, to achieve the same results are within the scope of the invention. Substitutions of elements from one described embodiment to another are also fully intended and contemplated. It is the intention, therefore, to be limited only as indicated by the scope of the claims appended hereto.

What is claimed is:

1. A motor vehicle window assembly comprising:
a first window frame member;
a stationary pane received by the first window frame member;
a window frame retainer member secured at a first end thereof to the first window frame member;
a second window frame member, a second end of the window frame retainer member being secured to the second window frame member; and
a movable pane movable along the second window frame member;
wherein the first and second window frame members are proximate one another and free of any structural members therebetween.

2. The motor vehicle window assembly of claim 1, further comprising a first seal positioned between a portion of the first window frame member and the second window frame member.

3. The motor vehicle window assembly of claim 1, further comprising a second seal positioned between the first window frame member and the stationary pane.

4. The motor vehicle window assembly of claim 1, wherein the second window frame member defines a run channel that receives the movable pane.

5. The motor vehicle window assembly of claim 1, further comprising
a first plurality of fasteners for securing the window retainer frame to the first window frame member; and
a second plurality of fasteners for securing the window retainer frame to the second window frame member.

6. The motor vehicle window assembly of claim 1, wherein the first plane is positioned inwardly with respect to the second plane.

7. A motor vehicle window assembly comprising:
a first window frame member;
a stationary pane received by the first window frame member and defining a first plane;
a window frame retainer member secured at a first end thereof to the first window frame member;
a second window frame member, a second end of the window frame retainer member being secured to the second window frame member; and
a movable pane movable along the second window frame member and defining a second plane, the first and second planes being substantially parallel to one another;
wherein a portion of the first window frame member and a portion of the second window frame member overlap one another along a third plane extending substantially parallel to the first and second planes.

8. The motor vehicle window assembly of claim 7, further comprising a first seal positioned between a portion of the first window frame member and the second window frame member.

9. The motor vehicle window assembly of claim 7, further comprising a second seal positioned between the first window frame member and the stationary pane.

10. The motor vehicle window assembly of claim 7, wherein the second seal is formed of an elastomeric material.

11. The motor vehicle window assembly of claim 7, wherein the second window frame member defines a run channel that receives the movable pane.

12. The motor vehicle window assembly of claim 7, further comprising
a first plurality of fasteners for securing the window retainer frame to the first window frame member; and
a second plurality of fasteners for securing the window retainer frame to the second window frame member.

13. The motor vehicle window assembly of claim 7, wherein the first plane is positioned inwardly with respect to the second plane.

14. A motor vehicle window assembly comprising:
a first window frame member;
a stationary pane received by the first window frame member and defining a first plane;
a window frame retainer member secured at a first end thereof to the first window frame member by a first plurality of fasteners;
a second window frame member, a second end of the window frame retainer member being secured to the second window frame member by a second plurality of fasteners;
a movable pane movable along the second window frame member and defining a second plane, the first and second planes being substantially parallel to one another; and
a first seal positioned between a portion of the first window frame member and the second window frame member;
a second seal positioned between the first window frame member and the second window frame member;
wherein a portion of the first window frame member and a portion of the second window frame member overlap one another along a third plane extending substantially parallel to the first and second planes.

15. The motor vehicle window assembly of claim 14, wherein the second window frame member defines a run channel that receives the movable pane.

16. A motor vehicle window assembly for a motor vehicle comprising:
a first modular portion including:
a first frame member,
a first light admitting pane supported by the first frame member, the first light admitting pane having an elongated horizontal portion and an elongated vertical portion;
a second modular portion including:
a second frame member,
a second movable light admitting pane supported by the second frame member,
regulator supported by the second modular portion and connected to the second movable light pane;
wherein the second modular portion is at least partially surrounded by the elongated horizontal portion and the elongated vertical portion of the first light admitting pane on at least two sides; and
wherein at least a portion of the first and the second frame members are coupled to one another to be self supporting, the combined first and second frame members defining a light obscuring portion between the elongated vertical portion and the second movable light admitting pane having a width that is less than about 2 inches.

17. The motor vehicle window assembly of claim 16, wherein the first light admitting pane is bonded to the first frame member.

18. The motor vehicle window assembly of claim 16, wherein the second frame includes a channel to guide the second movable light admitting pane.

19. The motor vehicle modular window assembly of claim 16, wherein the first and second frames are mechanically fastened on one side of the combined frame members and compression fit with a seal between the first and second frame members on another side of the combined frames.

20. The motor vehicle window assembly of claim 16, wherein the first and second frames comprise extruded aluminum with at least one bend to reinforce the frame against lateral loading.
